(19) United States
(12) Patent Application Publication
(10) Pub. No.: US 2026/0039957 A1
(43) Pub. Date: Feb. 5, 2026

(54) CONTROL APPARATUS, LENS APPARATUS, IMAGE PICKUP APPARATUS, AND STORAGE MEDIUM

(71) Applicant: CANON KABUSHIKI KAISHA, Tokyo (JP)

(72) Inventor: SHOTA NIKI, Kanagawa (JP)

(21) Appl. No.: 19/250,558

(22) Filed: Jun. 26, 2025

(30) Foreign Application Priority Data
Aug. 5, 2024 (JP) 2024-129061

(51) Int. Cl. H04N 23/68

(52) U.S. Cl. CPC H04N 23/687; H04N 23/6811

(57) ABSTRACT

A control apparatus includes one or more memories storing instructions, and one or more processors that, upon execution of the instructions, operate to acquire an output signal from a shake detector, control, based on the output signal, a first image stabilizing unit and a second image stabilizing unit that is driven at a frequency higher than that of the first image stabilizing unit and with a stroke smaller than that of the first image stabilizing unit, and change at least one of a first cutoff frequency that determines a first correction band for the first image stabilizing unit and a second correction band for the second image stabilizing unit and a second cutoff frequency that determines the second correction band, based on an image-plane blur amount of an image sensor.

### BACKGROUND

### Field of the Technology

The present disclosure relates to a control apparatus, a lens apparatus, an image pickup apparatus, a control method, and a storage medium.

### Description of the Related Art

As image pickup apparatuses have recently become more sophisticated, many image pickup apparatuses and lens apparatuses are equipped with image stabilizing mechanisms. The image stabilizing mechanism can reduce the influence of camera shake on a captured image. Known image stabilizing mechanisms use a method that performs image stabilization by driving a part of lenses in an imaging optical system (optical image stabilizing unit) and a method that performs image stabilization by driving an image sensor inside the camera body (in-camera image stabilizing unit). Another method is the combination that performs image stabilization by driving both a part of the lenses in the imaging optical system and the image sensor.

Japanese Patent Application Laid-Open No. 2015-194711 discloses an imaging system in which one of the optical image stabilizing unit and the in-camera image stabilizing unit performs image stabilization based on a low-frequency shake signal, and the other of the optical image stabilizing unit and the in-camera image stabilizing unit performs image stabilization based on a high-frequency shake signal.

Camera shake is primarily dominated by low-frequency shake of around 1 to 10 Hz, so an image stabilizing unit may have a stroke (large drive amount) that can sufficiently provide image stabilization at these frequencies. However, due to the characteristics of the actuator, in order to comprehensively correct high-frequency camera shake, an image stabilizing unit (actuator) with a large drive amount generally has a drive limit at high frequencies. Thus, the imaging system disclosed in Japanese Patent Application Laid-Open No. 2015-194711 has difficulty in performing high-definition image stabilization that corrects from low frequencies to high frequencies.

### SUMMARY

A control apparatus according to one aspect of the present disclosure includes one or more memories storing instructions, and one or more processors that, upon execution of the instructions, operate to acquire an output signal from a shake detector, control, based on the output signal, a first image stabilizing unit and a second image stabilizing unit that is driven at a frequency higher than that of the first image stabilizing unit and with a stroke smaller than that of the first image stabilizing unit, and change at least one of a first cutoff frequency that determines a first correction band for the first image stabilizing unit and a second correction band for the second image stabilizing unit and a second cutoff frequency that determines the second correction band, based on an image-plane blur amount of an image sensor. A lens apparatus and an image pickup apparatus each having the above control apparatus, a control method corresponding to the above control apparatus, and a storage medium storing a program that causes a computer to execute the above control method also constitute another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are a sectional view and a block diagram of an imaging system according to this embodiment, respectively.

FIG. 2 is a schematic diagram of a first optical image stabilizing unit and a second optical image stabilizing unit according to this embodiment.

FIGS. 3A, 3B, and 3C explain a pixel size in this embodiment.

FIGS. 4A and 4B explain the frequencies for correction (or image stabilization) according to this embodiment.

FIGS. 5A and 5B explain a first cutoff frequency in this embodiment.

FIG. 6 explains a second cutoff frequency in this embodiment.

FIG. 7 is a block diagram of a lens system controller according to this embodiment.

FIG. 8 is a flowchart illustrating processing of a lens-side image stabilizing unit according to this embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

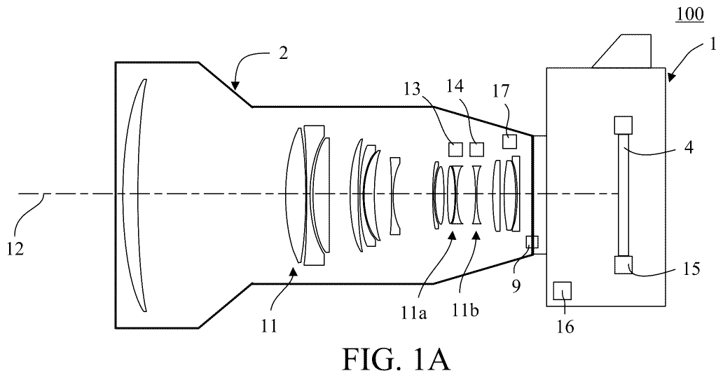

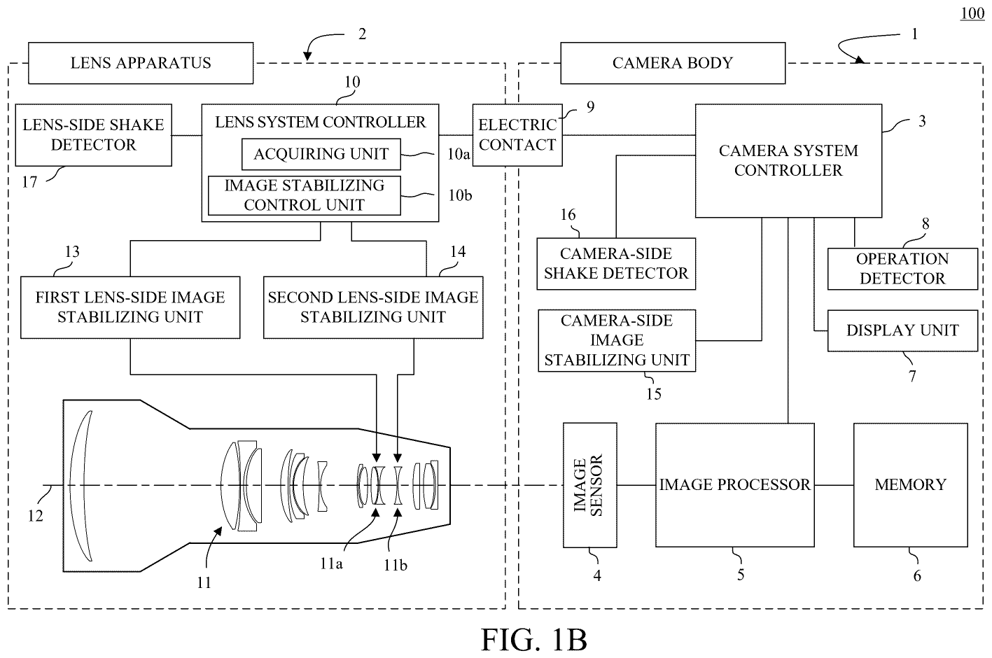

Referring now to FIGS. 1A and 1B, a description will be given of an imaging system 100 according to this embodiment. FIG. 1A is a central sectional view of the imaging system 100. FIG. 1B is a block diagram illustrating the electrical configuration of the imaging system 100. The imaging system 100 is a lens interchangeable type imaging system that includes a camera body (image pickup apparatus) 1 and a lens apparatus (interchangeable lens) 2 that is attachable to and detachable from the camera body 1. In this embodiment, the lens apparatus 2 includes a plurality of image stabilizing units (optical image stabilizing units or optical image stabilizers), including a first image stabilizing unit and a second image stabilizing unit.

In the lens interchangeable type imaging system, a lens apparatus having an optical image stabilizing unit may be used in combination with a camera body that has no in-camera image stabilizing unit, and a camera having an in-camera image stabilizing unit may be used in combination with a lens apparatus that has no optical image stabilizing unit. Thus, an image stabilizing unit with a large drive amount may be used for both combinations. However, this embodiment is not limited to the lens interchangeable type imaging system, but is applicable to an image pickup apparatus in which the camera body 1 and the lens apparatus 2 are integrated (the lens apparatus cannot be detached from the camera body).

This embodiment illustrates, but is not limited to, an example in which each of the camera body 1 and the lens apparatus 2 includes an image stabilizing unit. For example, this embodiment may also be applicable to an imaging system in which only the lens apparatus 2 has an image stabilizing unit.

In FIGS. 1A and 1B, reference numeral 3 denotes a camera system controller, reference numeral 4 denotes an image sensor, reference numeral 5 denotes an image processing unit, reference numeral 6 denotes a memory (unit), and reference numeral 7 denotes a display unit. Reference numeral 8 denotes an operation detector configured to detect a signal from an operation unit including a shutter release button (not illustrated). Reference numeral 9 denotes an electrical contact that enables communications between the camera body 1 and the lens apparatus 2. Reference numeral 10 denotes a lens system controller provided in the lens apparatus 2. Reference numeral 11 denotes an imaging optical system having a plurality of lens units provided in the lens apparatus 2. Reference numeral 12 denotes the optical axis in the imaging optical system 11.

Reference numerals 11a and 11b denote image stabilizing lenses that perform manual image stabilization. Reference numeral 13 denotes a first lens-side image stabilizing unit (first image stabilizing unit) configured to drive the image stabilizing lens (first correction lens) 11a at a large stroke (drive amount) and low speed in a plane orthogonal to an optical axis 12. Reference numeral 14 denotes a second lens-side image stabilizing unit (second image stabilizing unit) configured to drive the image stabilizing lens (second correction lens) 11b at a smaller stroke and higher speed than those of the first lens-side image stabilizing unit 13 in a plane orthogonal to the optical axis 12.

In this embodiment, the image stabilizing lens 11b is disposed closer to the image side than the image stabilizing lens 11a. However, this embodiment is not limited to this example, and the image stabilizing lens 11b may be driven using the first lens-side image stabilizing unit 13, and the image stabilizing lens 11a may be driven using the second lens-side image stabilizing unit 14.

Reference numeral 15 denotes a camera-side image stabilizing unit configured to drive an image sensor 4 in a plane orthogonal to the optical axis 12. Reference numeral 16 denotes a camera-side shake detector (shake detector) configured to detect a shake amount of the camera body 1 (imaging system 100). Reference numeral 17 denote a lens-side shake detector (shake detector) configured to detect a shake amount of the lens apparatus 2 (imaging system 100).

The imaging system 100, which has the camera body 1 and the lens apparatus 2, includes an imaging unit, an image processing unit, a recorder/playback unit, and a control unit. The imaging unit includes the imaging optical system 11 and the image sensor 4. The image processing unit includes an image processor 5. The recorder/playback unit includes a memory 6 and a display unit 7. The control unit includes the camera system controller 3, the operation detector 8, the camera-side shake detector 16, the camera-side image stabilizing unit 15, the lens system controller 10, the lens-side shake detector 17, the first lens-side image stabilizing unit 13, and the second lens-side image stabilizing unit 14. In addition to the image stabilizing lenses 11a and 11b, the lens system controller 10 can drive a focus lens and an aperture stop (not illustrated) using a drive unit (not illustrated).

The camera-side shake detector 16 and the lens-side shake detector 17 can detect rotational shake relative to the optical axis 12 applied to the imaging system 100, and are achieved by using, for example, a vibration gyro. The camera-side image stabilizing unit 15 drives the image sensor 4 on a plane orthogonal to the optical axis 12 based on a rotational shake amount detected by the camera-side shake detector 16 or the lens-side shake detector 17. The first lens-side image stabilizing unit 13 drives the image stabilizing lens 11a on a plane orthogonal to the optical axis 12 based on a rotational shake amount detected by the camera-side shake detector 16 or the lens-side shake detector 17. The second lens-side image stabilizing unit 14 drives the image stabilizing lens 11b on a plane orthogonal to the optical axis 12 based on a rotational shake amount detected by the camera-side shake detector 16 or the lens-side shake detector 17.

The camera-side shake detector 16 includes, for example, an acceleration sensor, and can detect translational shake applied to the imaging system 100. Therefore, the camera-side image stabilizing unit 15 drives the image sensor 4 on a plane orthogonal to the optical axis 12 based on the rotational shake and translational shake detected by the camera-side shake detector 16.

The imaging unit described above is an optical processing system that images light from an object on an imaging surface of the image sensor 4 via the imaging optical system 11. A focus evaluation amount and a proper exposure amount can be obtained from the image sensor 4. Therefore, by properly adjusting the imaging optical system 11 based on this signal, the image sensor 4 is exposed to a proper object light amount and an object image is formed near the image sensor 4.

The image processor 5 has an A/D converter, a white balance adjustment circuit, a gamma correction circuit, an interpolation calculation circuit, etc., and can generate an image for recording. The image processor 5 has a color interpolation processing unit that performs color interpolation (demosaicing) processing for the Bayer array signal to generate a color image. The image processor 5 also compresses a still image, a moving image, sounds, etc., using a predetermined method. The memory 6 has a storage unit. The camera system controller 3 outputs to a recorder in the memory 6 and displays an image to be presented to the user on the display unit 7.

The camera system controller 3 generates and outputs a timing signal for imaging. It controls the imaging system, image processing system, and recorder/playback system according to an external operation. For example, the operation detector 8 detects the pressing of a shutter release button (not illustrated), and the camera system controller 3 controls the driving of the image sensor 4, the operation of the image processor 5, compression processing, etc. The display unit 7 controls each segment state of the information display apparatus that displays information.

The lens system controller 10 has an acquiring unit 10a and an image stabilizing control unit 10b. The acquiring unit 10a acquires an output signal of the shake detector (camera-side shake detector 16 or lens-side shake detector 17). The image stabilizing control unit 10b controls the first lens-side image stabilizing unit 13 and the second lens-side image stabilizing unit 14 based on the output signal of the shake detector.

As a specific control method, the camera system controller 3 and the lens system controller 10 first detect a hand shake signal (rotational shake and translational shake) detected by the camera-side shake detector 16 and the lens-side shake detector 17, respectively. Based on the result, the camera system controller 3 and the lens system controller 10 respectively calculate drive amounts of the image sensor 4 and the image stabilizing lenses 11a and 11b for image stabilization. The calculated drive amounts are then output as drive command values to the camera-side image stabilizing unit 15, the first lens-side image stabilizing unit 13, and the second lens-side image stabilizing unit 14, which drive the image sensor 4 and the image stabilizing lenses 11a and 11b, respectively.

As described above, the camera system controller 3 and the lens system controller 10 control the operation of each component in the camera body 1 and the lens apparatus 2 according to user operation of the operation units (not illustrated) provided in the camera body 1 and the lens apparatus 2. Thereby, a still image and a moving image can be captured.

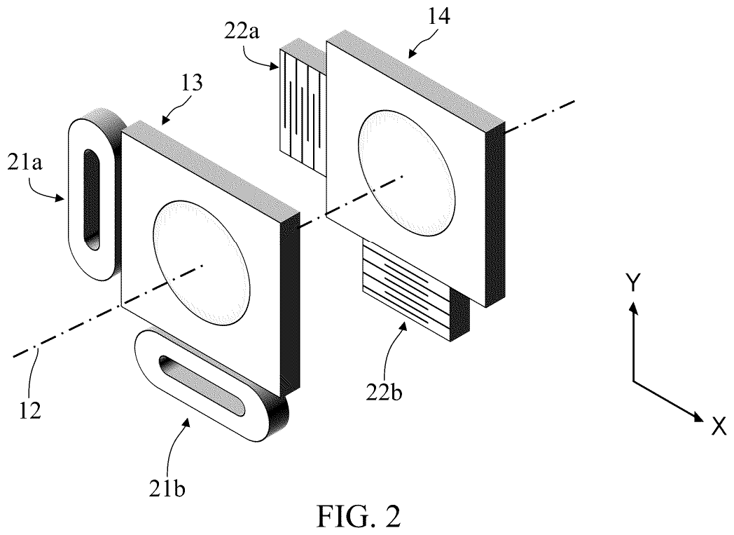

FIG. 2 is a schematic diagram of the first lens-side image stabilizing unit 13 and the second lens-side image stabilizing unit 14. The first lens-side image stabilizing unit 13 is responsible for image stabilization with a large stroke of about 1 to 10 Hz, which is dominant in hand shake correction, so it may use a voice coil motor with a relatively large, generated stroke compared to an actuator volume as the actuator. The second lens-side image stabilizing unit 14 is responsible for a relatively high frequency of about 10 Hz or more, and thus may use a piezoelectric actuator that can follow at high speed.

The lens system controller 10 calculates drive amounts for the image stabilizing lenses 11a and 11b based on the hand shake signal detected by the lens-side shake detector 17. The lens system controller 10 converts and outputs the drive amounts into a drive command value for driving the voice coil motors 21a and 21b for the first lens-side image stabilizing unit 13 and to a drive command value for driving the piezoelectric actuators 22a and 22b for the second lens-side image stabilizing unit 14.

### Pixel Size

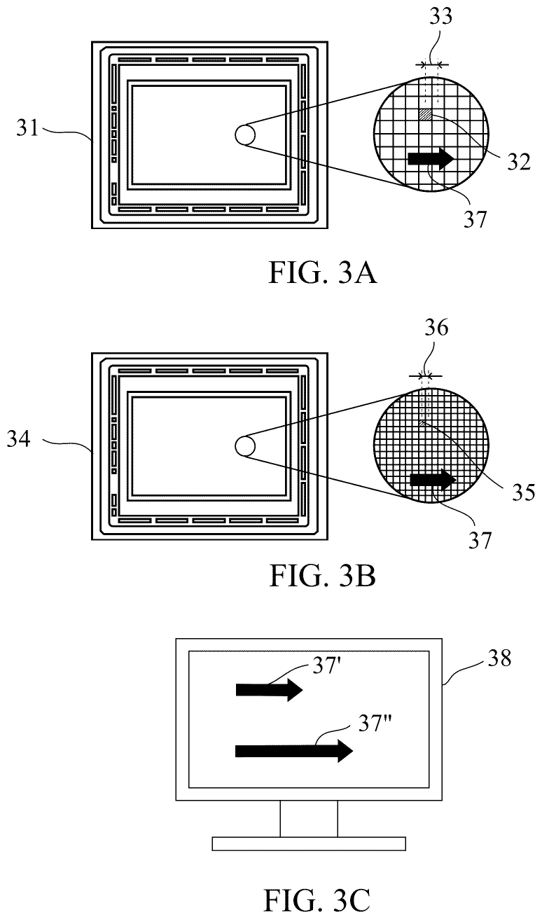

Referring now to FIGS. 3A, 3B, and 3C, a description will be given of the pixel size referenced to when the drive characteristic of the image stabilizing unit is changed in this embodiment. FIGS. 3A, 3B, and 3C explain the pixel size of the image sensor 4. FIG. 3A illustrates the image sensor with a certain pixel size, and FIG. 3B illustrates an image sensor with a pixel size smaller than that of FIG. 3A. FIG. 3C explains images captured with image sensors of different pixel sizes.

FIG. 3A illustrates an image sensor and its enlarged view. Reference numeral 31 indicates the image sensor, and reference numeral 32 denotes the pixel of image sensor 31. Arrow 33 indicates the pixel size of the image sensor 31. FIG. 3B illustrates an image sensor with higher resolution than that of the image sensor 31 in FIG. 3A and its enlarged view. Reference numeral 34 denotes the image sensor, and reference numeral 35 denotes the pixel of the image sensor 34. Arrow 36 indicates the pixel size of the image sensor 34. Arrow 37 is a schematic diagram illustrating a shake amount when the same shake amount acts on the image sensors 31 and 32.

In FIG. 3C, reference numeral 38 denotes a display unit for displaying an image, reference numeral 37′ denotes a blur amount when the blur 37 is imaged by the image sensor 31 and viewed at full size, and reference numeral 37″ denotes a blur amount when the blur 37 is imaged by the image sensor 34 and viewed at full size. As illustrated in FIGS. 3A and 3B, the pixel size 36 of the image sensor 34 is smaller than the pixel size 33 of the image sensor 31. Thus, in a case where an image is captured by an image pickup apparatus with the same-size image sensor and viewed at life-size on the same display as in FIG. 3C, small blurs are easily visible.

In this embodiment, in an imaging system with high resolution, the drive control parameter for the second lens-side image stabilizing unit 14 is changed so as to increase the responsiveness of the image stabilizing unit. In other words, in the case of a camera body including the image sensor 34 illustrated in FIG. 3B, the drive control parameter for the second lens-side image stabilizing unit 14 is changed so as to increase the responsiveness of the image stabilizing unit compared to that of a camera body including the image sensor 31 illustrated in FIG. 3A.

### Change in Drive Control Parameter

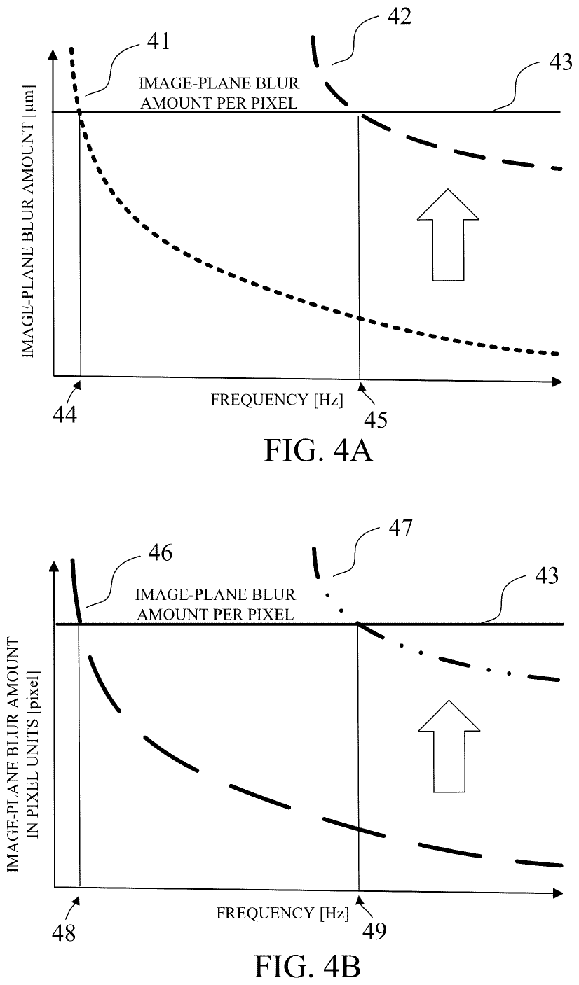

Referring now to FIGS. 4A and 4B, a description will be given of a relationship between the focal length or pixel size and the drive control parameter. FIGS. 4A and 4B explain a relationship between the image-plane blur amount and frequency before and after the focal length or pixel size is changed. FIG. 4A illustrates a change in the image-plane blur amount with a change in focal length. In FIG. 4A, a horizontal axis illustrates a frequency [Hz], and a vertical axis illustrates an image-plane blur amount [μm]. FIG. 4B illustrates a blur amount in pixel units with a change in pixel units. In FIG. 4B, a horizontal axis illustrates a frequency [Hz], and a vertical axis illustrates an image-plane blur amount [pixel] with a change in pixel units.

In FIG. 4A, curve 41 illustrates an image-plane blur amount in a case where a lens with a short focal length is used, curve 42 illustrates an image-plane blur amount in a case where a lens with a long focal length is used, and line 43 illustrates an image-plane blur amount for one pixel. Line 44 illustrates the frequency at which the curve 41 and line 43 intersect. Line 45 illustrates a frequency at which curve 42 and line 43 intersect.

In FIG. 4B, curve 46 illustrates an image-plane blur amount in pixel units in a case where an image sensor with a large pixel size such as the image sensor 31 is used. Curve 47 indicates an image-plane blur amount in pixel units in a case where an image sensor with a small pixel size such as the image sensor 32 is used. Straight line 48 indicates a frequency at which the curve 46 and the straight line 43 intersect. Straight line 49 indicates a frequency at which the curve 47 and the straight line 43 intersect.

Generally, for image stabilization, a drive amount and drive speed of the image stabilizing unit are calculated by multiplying a shake amount (angular shake amount) of the image pickup apparatus obtained by an inertial sensor such as a gyro sensor by a coefficient for converting it into a moving amount on the imaging surface of the image sensor 4 (image-plane blur amount). In a case where an object is considered to be infinitely far away, the focal length may be used as the coefficient for converting to the image-plane blur amount. In other words, even if the shake amount of the image pickup apparatus is the same, as the focal length increases, the peak values of the drive amount and drive speed for the image stabilizing unit increase.

Where θ is a shake amount detected by the lens-side shake detector 17, and L is a focal length, the image-plane blur amount is expressed as Lθ. Therefore, where L1 is a focal length for the curve 41, and L2 is a focal length for the curve 42 (L2>L1), the image-plane blur amount is L20>L10. Thus, as illustrated in FIG. 4A, as the focal length increases, the image-plane blur amount increases at each frequency.

Where Δp is a pixel size of the image sensor, the image-plane blur amount in pixel units based on life-size viewing on the display to be viewed is Lθ/Δp. Therefore, where Δp1 is the pixel size for the curve 46 and Δp2 is the pixel size for the curve 47 (Δp1>Δp2), for the same focal length L, the blur amount in pixel units is Lθ/Δp2>Lθ/Δp1. Thus, as illustrated in FIG. 4B, as the pixel size decreases, the image-plane blur amount in pixel units increases at each frequency. In other words, in a case where the image-plane blur amount represented by the line 43 is considered as the standard, the frequency at which the blur amount that exceeds the pixel size occurs expands to the high frequency side. Hence, variably changing the drive control parameter according to the focal length and pixel size can realize image stabilization with higher resolution than that of the conventional method.

In FIG. 4A, the blur amount becomes finer than the pixel size at higher frequencies than the line 44 in the case of the curve 41 and the blur amount becomes finer than the pixel size at higher frequencies than the line 45 in the case of the curve 42, so life-size viewing is not noticeable. In other words, the frequencies higher than the line 44 in the case of the curve 41 and higher than the line 45 in the case of the curve 42 are a frequency band that may not be corrected. In FIG. 4B, the blur amount becomes finer than the pixel size at frequencies higher than the line 48 in the case of the curve 46 and the blur amount becomes finer than the pixel size at frequencies higher than the line 49 in the case of the curve 47, so life-size viewing is not noticeable. In other words, the frequencies higher than the line 48 in the case of the curve 46 and higher than the line 49 in the case of the curve 47 are a frequency band that may not be corrected. In other words, variably changing the drive control parameter according to the focal length and pixel size can eliminate unnecessary correction processing and vibrations by the image stabilizing unit.

This embodiment determines the first cutoff frequency that determines (switches) the correction band (first correction band) of the first lens-side image stabilizing unit 13 and the correction band (second correction band) of the second lens-side image stabilizing unit 14, based on the focal length. This embodiment also changes the second cutoff frequency that determines (switches) the correction band (second correction band) of the second lens-side image stabilizing unit 14, based on the pixel size.

That is, in the case of an imaging system such as the curve 42, the first cutoff frequency is changed so as to widen the correction band of the image stabilizing unit more than that in the case of an imaging system such as the curve 41. On the other hand, in the case of an imaging system such as the curve 47, the second cutoff frequency is changed so as to remove unnecessary correction processing and vibrations more than those in the case of an imaging system such as the curve 46. However, this embodiment illustrates an example of an imaging system in which the first cutoff frequency is changed based on the focal length and the second cutoff frequency is changed based on the pixel size, but is not limited to this example. For example, the first cutoff frequency may be changed based on the pixel size, or the second cutoff frequency may be changed based on the focal length.

### Changing Cutoff Based on Focal Length and Pixel Size

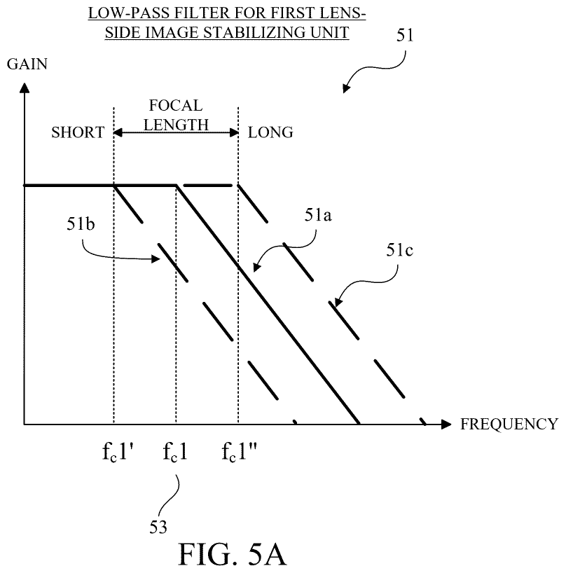

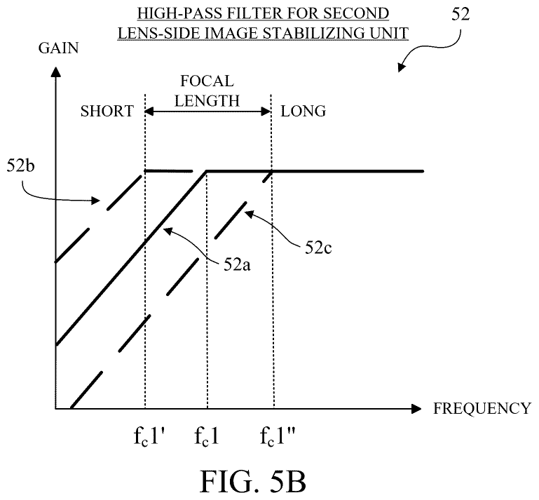

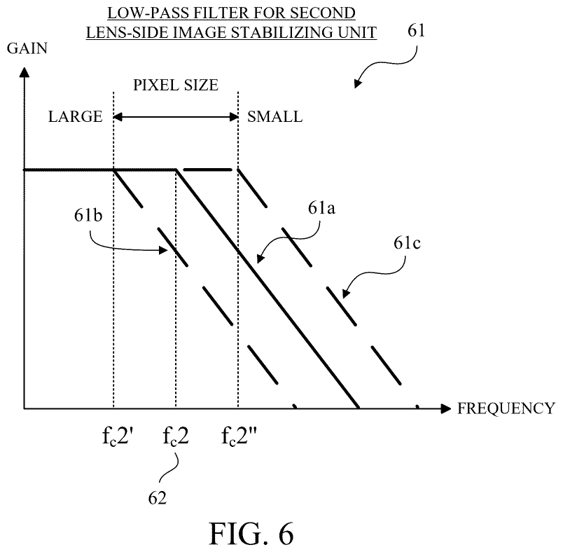

Referring now to FIGS. 5A, 5B, and 6, a description will be given of changing the driving characteristic of the image stabilizing unit based on the focal length and pixel size according to this embodiment. FIGS. 5A and 5B explain the driving characteristic that switch the correction bands of the first lens-side image stabilizing unit 13 and the second lens-side image stabilizing unit 14 based on the focal length. FIG. 5A illustrates the drive characteristic of the first lens-side image stabilizing unit 13. FIG. 5B illustrates the drive characteristic of the second lens-side image stabilizing unit 14. FIG. 6 explains the drive characteristic for switching the correction band of the second lens-side image stabilizing unit 14 based on the pixel size.

In FIG. 5A, reference numeral 51 denotes a relationship between frequency and gain of the first lens-side image stabilizing unit 13, which changes the cutoff frequency (first cutoff frequency) f_{c}1 based on focal length. In FIG. 5B, reference numeral 52 denotes a relationship between frequency and gain of the second lens-side image stabilizing unit 14, which changes the cutoff frequency f_{c}1 based on focal length.

Curve 51a illustrates a low-pass filter (LPF) at cutoff frequency f_{c}1, curve 51b illustrates a low-pass filter at cutoff frequency f_{c}1′, and curve 51c illustrates a low-pass filter at cutoff frequency f_{c}1″. Curve 52a illustrates a high-pass filter (HPF) at cutoff frequency f_{c}1, curve 52b illustrates a high-pass filter at cutoff frequency f_{c}1′, and curve 52c illustrates a high-pass filter at cutoff frequency f_{c}1″. Reference numeral 53 denotes the cutoff frequency f_{c}1.

In FIG. 6, reference numeral 61 denotes a relationship between the frequency and gain of the second lens-side image stabilizing unit 14, which changes the cutoff frequency (second cutoff frequency) f_{c}2 based on the pixel size of the image sensor 4. Curve 61a illustrates a low-pass filter at cutoff frequency f_{c}2, curve 61b illustrates a low-pass filter at cutoff frequency fc2′, and curve 61c illustrates a low-pass filter at cutoff frequency f_{c}2″. Reference numeral 62 denotes the cutoff frequency f_{c}2.

As described above, when the focal length L changes at the image-plane blur amount Lθ, the frequency band for image stabilization differs. Therefore, a wide range of frequencies can be supported by the first lens-side image stabilizing unit 13, which is driven with a large stroke and at a low speed, and the second lens-side image stabilizing unit 14, which is driven with a smaller stroke and at a higher speed than those of the first lens-side image stabilizing unit 13. However, it is difficult to drive an actuator (such as a voice coil motor) that is driven with a large stroke, at high speed, and it is difficult to increase the stroke of an actuator (such as a piezoelectric actuator) that can operate at high speed. In other words, in order to perform image stabilization without stroking out the entire frequency band to be image-stabilized, it is necessary to switch the correction bands of the first lens-side image stabilizing unit 13 and the second lens-side image stabilizing unit 14 based on the focal length.

Where L is a focal length and f_{c}1 is a cutoff frequency, the curve 51a functions as a low-pass filter for the first lens-side image stabilizing unit 13, and the curve 52a functions as a high-pass filter for the second lens-side image stabilizing unit 14. When the focal length changes to L′, which is shorter than L, Lθ>L′θ, so the strokes at which the first and second lens-side image stabilizing units are driven may be small. Therefore, the cutoff frequency is changed to f_{c}1′, which is smaller than f_{c}1, to increase the frequency band managed by the second lens-side image stabilizing unit 14 for high-speed driving. Thereby, the curve 51b functions as a low-pass filter for the first lens-side image stabilizing unit 13, and the curve 52b functions as a high-pass filter for the second lens-side image stabilizing unit 14.

When the focal length changes to L″, which is longer than L, Lθ<L″θ, so the strokes at which the first and second lens-side image stabilizing units are driven may be increased. Therefore, the cutoff frequency is changed to f_{c}1″, which is larger than f_{c}1, to increase the frequency band managed by the first lens-side image stabilizing unit 13 for drive with a large stroke. Thereby, the curve 51c functions as a low-pass filter for the first lens-side image stabilizing unit 13, and the curve 52bc functions as a high-pass filter for the second lens-side image stabilizing unit 14. As a result, image stabilization with higher resolution than before can be achieved.

As described above, when the pixel size Δp in pixel units changes at the image-plane blur amount Lθ/Δp, the frequency band that may not be corrected (the frequency band in which the blur becomes smaller than the pixel size) changes. In other words, the correction band of the second lens-side image stabilizing unit 14 may be switched based on the pixel size.

Where Δp is a pixel size and f_{c}2 is a cutoff frequency, curve 61a functions as a low-pass filter for the second lens-side image stabilizing unit 14. When the pixel size changes to Δp′ larger than Δp, Lθ/Δp>Lθ/Δp′, so the upper limit of the frequency at which the second lens-side image stabilizing unit 14 is driven may be small. Therefore, the cutoff frequency is changed to f_{c}2′ which is smaller than f_{c}2, and curve 61b functions as a low-pass filter for the second lens-side image stabilizing unit 14. When the pixel size changes to Δp″ which is larger than Δp, Lθ/Δp<Lθ/Δp “, so the upper limit of the frequency at which the second lens-side image stabilizing unit 14 is driven may be increased. Therefore, the cutoff frequency is changed to f_{c}2” which is larger than f_{c}2, and curve 61c functions as a low-pass filter for the second lens-side image stabilizing unit 14. As a result, unnecessary correction processing and vibrations can be removed.

As described above, when the focal length L changes at the image-plane blur amount Lθ, the frequency band for image stabilization differs. Therefore, a wide range of frequencies can be supported by the first lens-side image stabilizing unit 13, which is driven with a large stroke and at a low speed, and the second lens-side image stabilizing unit 14, which is driven with a smaller stroke and at a higher speed than those of the first lens-side image stabilizing unit 13. However, it is difficult to drive an actuator with a large stroke (such as voice coil motors), at a high speed, and it is difficult to increase the stroke of an actuator that can be driven at a high speed (such as a piezoelectric actuator). In other words, in order to perform image stabilization without stroking out the entire frequency band to be image-stabilized, it is necessary to switch the correction bands of the first lens-side image stabilizing unit 13 and the second lens-side image stabilizing unit 14 based on the focal length.

Where L is a focal length and f_{c}1 is a cutoff frequency, and the curve 51a functions as a low-pass filter for the first lens-side image stabilizing unit 13, and the curve 52a functions as a high-pass filter for the second lens-side image stabilizing unit 14. When the focal length changes to L′, which is shorter than L, Lθ>L′θ, so the stroke at which the lens-side image stabilizing unit is driven may be small. Therefore, the cutoff frequency is changed to f_{c}1′, which is smaller than f_{c}1, to increase the frequency band managed by the second lens-side image stabilizing unit 14 for high-speed driving. Thereby, the curve 51b functions as a low-pass filter for the first lens-side image stabilizing unit 13, and the curve 52b functions as a high-pass filter for the second lens-side image stabilizing unit 14.

When the focal length changes to L″, which is longer than L, Lθ<L″θ, so the stroke at which the lens-side image stabilizing unit is driven may be increased. Therefore, the cutoff frequency is changed to f_{c}1″, which is larger than f_{c}1, to increase the frequency band managed by the first lens-side image stabilizing unit 13 for drive with a large stroke. Thereby, the curve 51c functions as a low-pass filter for the first lens-side image stabilizing unit 13, and the curve 52bc functions as a high-pass filter for the second lens-side image stabilizing unit 14. As a result, image stabilization with higher resolution than before can be achieved.

As described above, when the pixel size Δp in pixel units changes at the image-plane blur amount Lθ/Δp, the frequency band that may not be corrected changes. In other words, the correction band of the second lens-side image stabilizing unit 14 may be switched based on the pixel size. When Δp is a pixel size and f_{c}2 is a cutoff frequency, the curve 61a functions as a low-pass filter for the second lens-side image stabilizing unit 14. When the pixel size changes to Δp″ larger than Δp, Lθ/Δp>Lθ/Δp′, so the upper limit of the frequency at which the second lens-side image stabilizing unit 14 is driven may be small. Therefore, the cutoff frequency is changed to f_{c}2′ smaller than f_{c}2, and the curve 61b functions as a low-pass filter for the second lens-side image stabilizing unit 14. When the pixel size changes to Δp″ larger than Δp, Lθ/Δp<Lθ/Δp “, so the upper limit of the frequency at which the second lens-side image stabilizing unit 14 is driven may be increased. Therefore, the cutoff frequency is changed to f_{c}2”, which is larger than f_{c}2, and the curve 61c functions as a low-pass filter for the second lens-side image stabilizing unit 14. As a result, unnecessary correction processing and vibrations can be eliminated.

### Control of Lens-Side Image Stabilizing Unit

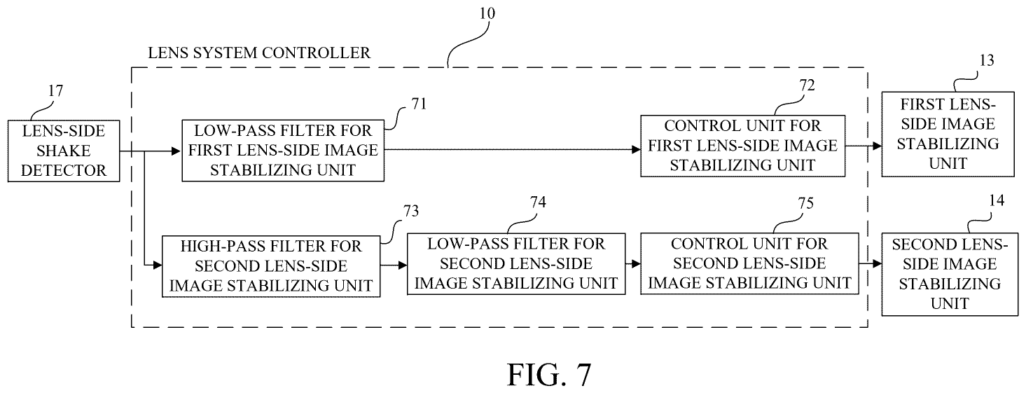

Referring now to FIG. 7, a description will be given of the control unit that determines the drive characteristic of the image stabilizing unit according to this embodiment. FIG. 7 is a block diagram that explains processing performed inside the lens system controller 10 when drive command values to the first lens-side image stabilizing unit 13 and the second lens-side image stabilizing unit 14 are output based on a hand shake signal detected by the lens-side shake detector 17.

In FIG. 7, reference numeral 71 denotes a low-pass filter for the first lens-side image stabilizing unit 13 set by the cutoff frequency f_{c}1. Reference numeral 72 denotes a control unit that calculates a drive amount of the first lens-side image stabilizing unit 13 based on the hand shake signal. Reference numeral 73 denotes a high-pass filter of the second lens-side image stabilizing unit 14 set by cutoff frequency f_{c}1. Reference numeral 74 denotes a low-pass filter of the second lens-side image stabilizing unit 14 set by cutoff frequency f_{c}2. Reference numeral 75 denotes a control unit that calculates a drive command value for the second lens-side image stabilizing unit 14 based on the hand shake signal.

An input signal is a shake signal detected by the lens-side shake detector 17. The input signal is separated into a shake signal containing only low frequency components by the low-pass filter 71 calculated based on the cutoff frequency f_{c}1, and a shake signal containing only high frequency components by the high-pass filter 73 calculated based on the cutoff frequency f_{c}1. The high-pass filter 73 is calculated as “1−(signal of the low-pass filter 71)” to facilitate calculation due to the nature of signal processing. Thus, a filter calculated as “1−(signal of the low-pass filter 71)” may be used.

From the high-frequency components in the shake signal separated by the high-pass filter 73, a low-pass filter 74, which is calculated based on the cutoff frequency f_{c}2, removes signals including noise unnecessary for processing. The low-frequency components in the shake signal that passed through the low-pass filter 71 are converted into a drive amount for the first lens-side image stabilizing unit 13 by the control unit 72 for the first lens-side image stabilizing unit 13, which drives the first lens-side image stabilizing unit 13. The high-frequency components in the shake signal that has passed through the high-pass filter 73 and the low-pass filter 74 are converted into a drive amount for the second lens-side image stabilizing unit 14 by the control unit 75 for the second lens-side image stabilizing unit 14, which drives the second lens-side image stabilizing unit 14.

Thus, this embodiment separates the shake signal based on the cutoff frequencies f_{c}1 and f_{c}2, and changes the cutoff frequencies f_{c}1 and f_{c}2 according to the imaging condition such as focal length or pixel size. Thereby, the first lens-side image stabilizing unit 13 and the second lens-side image stabilizing unit 14 can be properly driven, and the drive frequency band for image stabilization can be expanded.

### Control Flow for Lens-Side Image Stabilizing Unit

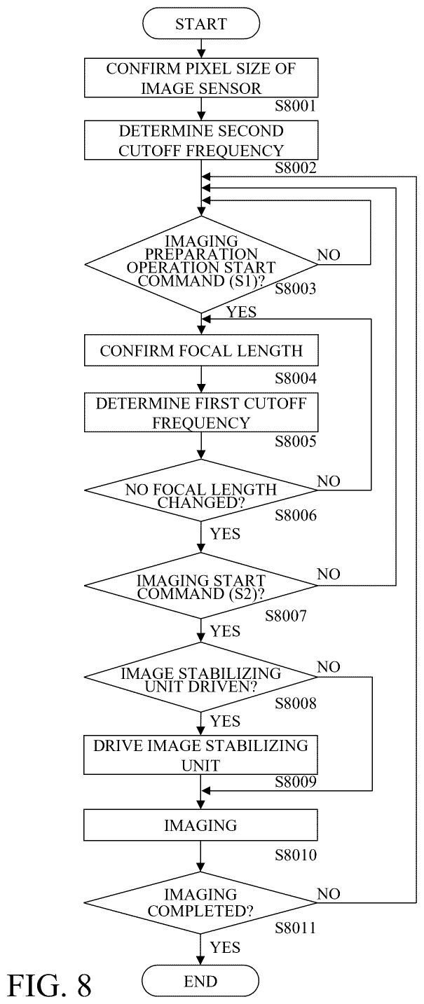

Referring now to FIG. 8, a description will be given of processing of the lens-side image stabilizing unit according to this embodiment. FIG. 8 is a flowchart illustrating the processing of the lens-side image stabilizing unit according to this embodiment. This flow starts when the image pickup apparatus is powered on.

First, in step S8001, the lens system controller 10 confirms the pixel size of the image sensor 4 in the camera body 1. The lens system controller 10 can confirm the pixel size of the image sensor 4, for example, by reading out the pixel size stored in the memory 6. Alternatively, the lens system controller 10 may confirm the model number of the camera body 1 as information on the pixel size of the image sensor, since the model number (type) of the camera body 1 and the pixel size of the image sensor are associated.

Next, in step S8002, the lens system controller 10 determines the second cutoff frequency based on the pixel size of the image sensor 4. For example, the second cutoff frequency associated with the pixel size, the image-plane blur amount when a predetermined blur amount is applied or the image-plane blur amount in pixel size units is stored in the memory 6. The lens system controller 10 can determine the second cutoff frequency by reading out the data stored in the memory 6.

Next, in step S8003, the lens system controller 10 determines whether or not the user has input an imaging preparation start command (so-called half-pressing the shutter release button, S1). In a case where it is determined that the imaging preparation start command has been input, the flow proceeds to step S8004. On the other hand, in a case where it is determined that the imaging preparation start command has not been input, the flow waits.

In step S8004, the lens system controller 10 confirms the focal length of the lens apparatus 2. The lens system controller 10 can confirm the focal length, for example, by acquiring focal length information on the lens apparatus 2.

Next, in step S8005, the lens system controller 10 determines the first cutoff frequency based on the focal length. For example, the first cutoff frequency associated with the focal length, the image-plane blur amount when a predetermined blur amount is applied, or the image-plane blur amount in pixel size units is stored in the memory 6. The lens system controller 10 can determine the first cutoff frequency by reading the data stored in the memory 6.

Next, in step S8006, the lens system controller 10 determines whether the focal length of the lens apparatus 2 has been changed by the user. In a case where it is determined that the focal length has not been changed, the flow proceeds to step S8007. On the other hand, in a case where it is determined that the focal length has been changed, the flow returns to step S8004. In a case where the lens apparatus 2 is a zoom lens, the first cutoff frequency may be changed whenever the focal length is changed, so the determination is made in step S8006.

In step S8007, the camera system controller 3 determines whether the user has input an imaging start instruction (so-called fully pressing the shutter release button, S2). In a case where it is determined that the imaging start command has been input, the flow proceeds to step S8008. On the other hand, in a case where it is determined that the imaging start command has not been input, the flow returns to step S8003.

In step S8008, the camera system controller 3 determines whether or not the user has input an image stabilization command (turning on or off of the image stabilization setting). In a case where it is determined that image stabilization is to be performed, the flow proceeds to step S8009. On the other hand, in a case where it is determined that image stabilization is not to be performed, the flow proceeds to step S8010.

In step S8009, the lens system controller 10 starts driving the image stabilization control unit. At this time, the lens system controller 10 may determine, for example, a threshold value of a focal length in advance. In a case where the focal length is shorter than the threshold value (predetermined threshold value), the lens system controller 10 may stop driving the second lens-side image stabilizing unit 14 and drive only the first lens-side image stabilizing unit 13. As a result, unnecessary correction processing and vibrations can be eliminated.

In step S8010, the camera system controller 3 starts exposing the image sensor 4 to perform imaging. Next, in step S8011, the camera system controller 3 determines whether or not to end imaging based on user input, etc. In a case where it is determined that imaging is to be ended, this flow ends. On the other hand, in a case where it is determined that imaging is not to be ended, the flow returns to step S8003.

In FIG. 8, the lens system controller 10 controls the lens-side image stabilizing unit in each processing of steps S8001 to S8006, but this is not limited to the above. Instead of the lens system controller 10, or together with the lens system controller 10, the camera system controller 3 may control the lens-side image stabilizing unit.

In FIG. 8, after the confirmation of the pixel size in step S8001 and the determination of the cutoff frequency in step S8002, the determination of the imaging preparation start command is performed in step S8003, but the order is not limited to this example. For example, the order may be such that after the determination of whether the imaging preparation start command has been input, the pixel size is confirmed and the second cutoff frequency is determined based on the pixel size. This control flow is synonymous with changing the frequency based on the image-plane blur amount during aiming (during imaging preparation before imaging operation) or the image-plane blur amount in pixel size units.

FIG. 8 illustrates the control flow for still image capturing, but a similar control flow can also be used for moving image capturing.

This embodiment provides the first lens-side image stabilizing unit 13 and the second lens-side image stabilizing unit 14, and properly switches the cutoff frequency according to the imaging condition. Thereby, this embodiment can expand the drive frequency band for image stabilization without hindering low-frequency image stabilization, and can provide higher-definition image stabilization. This embodiment switches the cutoff frequency f_{c}2. Thereby, this embodiment can eliminate unnecessary correction processing and vibrations of the image stabilizing unit.

This embodiment provides the first and second image stabilizing units in the lens apparatus 2, but is not limited to this example. This embodiment is also applicable to a configuration in which the first and second image stabilizing units are provided only in the camera body (a configuration that can drive the image sensor using each of the first and second image stabilizing units). In other words, the camera-side shake detector 16 may include the first and second image stabilizing units.

This embodiment is also applicable to a configuration in which one of the first image stabilizing unit and the second image stabilizing unit is provided to the lens apparatus, and the other of the first image stabilizing unit and the second image stabilizing unit is provided to the camera body.

This embodiment is also applicable to an example in which the first image stabilizing unit and the second image stabilizing unit are provided to both the lens apparatus and the camera body (a total of four image stabilizing units as an imaging system).

This embodiment can expand the drive frequency band for image stabilization without hindering low-frequency image stabilization. Therefore, this embodiment can provide a control apparatus, lens apparatus, image pickup apparatus, control method, and storage medium, each of which can perform higher-resolution image stabilization.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-129061, which was filed on Aug. 5, 2024, and which is hereby incorporated by reference herein in its entirety.

What is claimed is:

1. A control apparatus comprising:
one or more memories storing instructions; and
one or more processors that, upon execution of the instructions, operate to:
acquire an output signal from a shake detector,
control, based on the output signal, a first image stabilizing unit and a second image stabilizing unit that is driven at a frequency higher than that of the first image stabilizing unit and with a stroke smaller than that of the first image stabilizing unit, and
change at least one of a first cutoff frequency that determines a first correction band for the first image stabilizing unit and a second correction band for the second image stabilizing unit and a second cutoff frequency that determines the second correction band, based on an image-plane blur amount of an image sensor.

2. The control apparatus according to claim 1, wherein the first cutoff frequency and the second cutoff frequency are cutoff frequencies for a low-pass filter, and
wherein the second cutoff frequency is higher than the first cutoff frequency.

3. The control apparatus according to claim 1, wherein the one or more processors operate to stop driving the second image stabilizing unit in a case where a focal length of an imaging optical system is shorter than a predetermined threshold value.

4. The control apparatus according to claim 1, wherein the first image stabilizing unit is driven by a voice coil motor, and
wherein the second image stabilizing unit is driven by a piezoelectric actuator.

5. The control apparatus according to claim 1, wherein the one or more processors operate to change the first cutoff frequency based on a focal length of an imaging optical system.

6. The control apparatus according to claim 1, wherein the one or more processors operate to change the second cutoff frequency based on a pixel size of the image sensor.

7. The control apparatus according to claim 1, wherein the one or more processors operate to change at least one of the first cutoff frequency and the second cutoff frequency based on the image-plane blur amount during aiming.

8. The control apparatus according to claim 1, wherein the image-plane blur amount is a moving amount on an imaging surface of the image sensor in a case where a predetermined blur amount is applied to the image sensor.

9. The control apparatus according to claim 1, wherein the image-plane blur amount is an image-plane blur amount in pixel units of the image sensor.

10. A lens apparatus comprising:
a control apparatus; and
an imaging optical system,
wherein the control apparatus includes:
one or more memories storing instructions; and
one or more processors that, upon execution of the instructions, operate to:
acquire an output signal from a shake detector,
control, based on the output signal, a first image stabilizing unit and a second image stabilizing unit that is driven at a frequency higher than that of the first image stabilizing unit and with a stroke smaller than that of the first image stabilizing unit, and
change at least one of a first cutoff frequency that determines a first correction band for the first image stabilizing unit and a second correction band for the second image stabilizing unit and a second cutoff frequency that determines the second correction band, based on an image-plane blur amount of an image sensor.

11. The lens apparatus according to claim 10, wherein the imaging optical system includes a first correction lens and a second correction lens,
wherein the first image stabilizing unit drives the first correction lens in a plane orthogonal to an optical axis, and
wherein the second image stabilizing unit drives the second correction lens in a plane orthogonal to the optical axis.

12. The lens apparatus according to claim 11, wherein the second correction lens is disposed on an image side relative to the first correction lens.

13. An image pickup apparatus comprising:
a control apparatus; and
an image sensor,
wherein the control apparatus includes:
one or more memories storing instructions; and
one or more processors that, upon execution of the instructions, operate to:
acquire an output signal from a shake detector,
control, based on the output signal, a first image stabilizing unit and a second image stabilizing unit that is driven at a frequency higher than that of the first image stabilizing unit and with a stroke smaller than that of the first image stabilizing unit, and
change at least one of a first cutoff frequency that determines a first correction band for the first image stabilizing unit and a second correction band for the second image stabilizing unit and a second cutoff frequency that determines the second correction band, based on an image-plane blur amount of an image sensor.

14. A control method comprising:
acquiring an output signal from a shake detector,
controlling, based on the output signal, a first image stabilizing unit and a second image stabilizing unit that is driven at a frequency higher than that of the first image stabilizing unit and with a stroke smaller than that of the first image stabilizing unit, and
changing at least one of a first cutoff frequency that determines a first correction band for the first image stabilizing unit and a second correction band for the second image stabilizing unit and a second cutoff frequency that determines the second correction band, based on an image-plane blur amount of an image sensor.

15. A non-transitory computer-readable storage medium storing a program that causes a computer to execute the control method according to claim 14.
